(19) United States
(12) Patent Application Publication
(10) Pub. No.: US 2005/0150743 A1
(43) Pub. Date: Jul. 14, 2005

(54) Wane orientation board turner

(76) Inventor: Deane Henderson, Salmon Arm (CA)

Correspondence Address: ANTONY C. EDWARDS, SUITE 800 - 1708 DOLPHIN AVENUE, KELOWNA, BC, V1Y 9S4, CA

(21) Appl. No.: 11/029,338

(22) Filed: Jan. 6, 2005

Related U.S. Application Data
(60) Provisional application No. 60/534,684, filed on Jan. 8, 2004.
(60) Provisional application No. 60/549,167, filed on Mar. 3, 2004.

(51) Int. Cl. B65G 47/24

(52) U.S. Cl. 198/403

(57) ABSTRACT

A device for selectively inverting a workpiece about the longitudinal axis of the workpiece within a single lug space of a lugged transfer without impeding lumber flow along a flow path on the lugged transfer, wherein the device includes a workpiece speed-up for urging the workpiece at an increased translation speed along the flow path, a selectively operable workpiece brake to inhibit accelerated translation of the workpiece by the workpiece speed-up so as to selectively at least momentarily delay translation of the workpiece at the increased translation speed of the workpiece speed-up, and a workpiece turning arm mounted downstream along the workpiece speed-up. The board turning arm is selectively actuable into the flow path so as to invert the workpiece about its longitudinal axis within a corresponding lug space of the lugged transfer once the workpiece has been translated by the speed-up to a downstream end of the corresponding lug space.

### CROSS REFERENCE TO RELATED APPLICATION

This application claims priority from U.S. Provisional Patent Applications No. 60/534,684 filed Jan. 8, 2004 and No. 60/549,167 filed Mar. 3, 2004 both entitled Wane Orientation Board Turner.

### FIELD OF THE INVENTION

This invention relates to a high-speed board turner for selectively inverting lumber pieces of varying widths 180 degrees about their longitudinal axis while the board remains within the same lug space of a lugged transfer and without varying the speed of the lugged transfer. The board turner is located in front of a planer, and is used to maximize the grade recovery of a piece of wood by allowing the worst face and edge to be oriented away from the linebar and bed plate.

### BACKGROUND OF THE INVENTION

Wane orientation has normally been done within a sawmill where a photo eye or scanner has identified a round back or a wane in a board for grade evaluation or trimming. Further optimising can then identify the finished board within the rough lumber piece. The optimizer sends a signal to the programmable logic controller (PLC) to spray candidate boards with a mark which identifies the best face to present upwards, and/or the best edge to present outwards when the board arrives at the planer.

In the prior art, wane orientation has been accomplished by installing a scanner or photo-eye in front of the planer and automatically turning the piece about its longitudinal axis. Prior art board turners previously used are incapable of evaluating the correct face and edge solutions together, and therefore only consider one or the other. Recent improvements have allowed others to evaluate both the face and the edge considerations, and score one decision against the other; however they cannot combine the best of both evaluations without the ability to do the “end orientation” as defined below according to the present invention.

In applicant's opinion, one way to maximize recovery with wane orientation is to evaluate wave orientation in the sawmill, then sort it by “end orientation”, and then to present the correctly end-orientated pieces to the planer infeed in such a way that the piece may be correctly top/bottom orientated in front of the planer.

In the prior art the applicant is aware of U.S. Pat. No. 5,685,410 which issued Nov. 11, 1997 to Ritola et al, for an Infeed Conveyor System. This system generally comprises a first lugged infeed conveyor and a second friction conveyor. The first conveyor is intermittently operated through remote board scanning means and the second friction conveyor, which has a higher rate of speed than the first, advances any board positioned thereon into contact with a preceding lug on the stationary first conveyor at a predetermined board turning station. A board turner arm positioned at this station is intermittently operable to contact and to arcuately elevate the leading edge of the stationary board. Rotation of the friction conveyor results in forward movement of the trailing edge of the board with the result that the board rides upwardly and rearwardly against the turner arm flipping the board over backwards.

It is an object of the present invention to provide a high-speed board turning device which will selectively invert only previously identified lumber pieces 180 degrees about their longitudinal axis so as to position the wane side of the lumber piece uppermost without impeding the speed of a lugged lumber carrying transfer in a sawmill.

It is an object of the present invention to provide a high-speed board turning device, which is in continuous operation with a constant actuation period, which cooperates with ancillary means that varies the travel speed of a board within a single lug space.

It is a further object of the present invention to provide ancillary board turning means comprising, in part, a continuously operating smooth surfaced speed-up friction belt or chain, positioned laterally of the board turning device, the speed of which is greater than that of the lugged transfer. Lumber pieces which are brought into contact with this speed-up friction belt by operation of the lugged transfer are immediately accelerated to the downstream lug within the same lug space of the lugged transfer, so as to enable contact by the board turning device, with the leading edge of the lumber piece at the downstream end of the lug space.

It is an object of the present invention to provide ancillary board turning means comprising, in part, a selectively operable lift skid, positioned laterally of the board turning device, which will momentarily elevate a lumber piece free from surface contact with the speed-up friction belt or chain so as to avoid its downstream translation into contact with the continuously operating board turning device.

### SUMMARY OF THE INVENTION

The present invention is a high speed board turner, which is well suited for placement in either a sawmill or planer mill and which selectively inverts lumber pieces (workpieces) of varying widths about their longitudinal axis within a single lug space of a lugged transfer without impeding lumber flow on a lugged transfer. The high speed board turner may advantageously operate in cooperation with an optimiser and scanner, and includes a workpiece speed-up such as for example a continuously operating smooth surfaced speed-up friction belt or chain (collectively, and without limiting, referred to herein as a board speed-up), positioned laterally of the board turning device. A selectively operable lift skid is also positioned laterally of the board turning device, which momentarily elevates a lumber piece free from surface contact with the board speed-up.

In a planer mill operation, by way of example, all lumber carried by the lugged transfer must be previously sorted so that the wane end is remote from the fixed planer knives. The board turner must operate to invert boards so that the wane side is uppermost. This allows the adjustable planer knives to remove sufficient wood to produce a high quality finished board.

In one embodiment of the present invention, the continuously rotating high-speed board turning device includes a plurality of chain driven dog-leg shaped turning arms having connecting pins mounted at both a medial and distal point for respective rotatable mounting to a continuously rotating arm drive chain on one side of each arm and a follower wheel mounted for following in stationary cam track located on the other side of the arms. The dog-leg shape of each arm includes an arcuate board contact leg located at the end opposite to the follower wheel end of each arm. The arm drive chain and cam track respectively lie in parallel vertical first and second planes which are parallel to the long axes of the chains. The arms lie in a third plane sandwiched between the first and second planes. The track has a dip along its path at, generally, a board turning location on the board transfer. The track dips arcuately downwards toward the rotational axis of the drive chain. The follower wheel follows the dip in the path thereby lowering the corresponding distal end of the corresponding arm. This pivots the arm about its pin at the medial point, thereby elevating the opposite end of the arm, that is the end shaped as an upwardly extending arcuate leg. Where the drive chain and cam track are generally parallel the arcuate contact leg of each turning arm is kept below the upper surface of the lugged board transfer. As the cam track diverges into its dip, that is from parallel to the turning arm drive chain, the distal end of the turning arm follows the dip in the track forcing the rotation of the turning arm about the medial connecting pin and elevating the arcuate contact leg of the turning arms proud of the upper surface of the lugged board transfer. As a consequence the leg contacts and elevates any lumber piece positioned over the leg in the corresponding lug space.

A continuously operating smooth surfaced speed-up friction belt or chain is positioned laterally of the high-speed board turning device. The speed of rotation of the speed-up friction belt is substantially faster than that of the lugged board transfer so that any lumber piece contacting the speed-up means is accelerated from the upstream transporting lug to the adjacent downstream lug within the same one lug space of the lugged board transfer. When the lumber piece has been sped-up within its lug space so as to be brought into contact with or adjacent to the downstream lug of the lugged board transfer, a corresponding turning arm moving at the speed of, and in the direction of the board transfer, enters the divergent dip path zone, that is where the follower wheel follows the dip in the track, so that the arcuate contact leg of the turning arm is elevated to contact the leading edge of the lumber piece on the downstream lug. Further elevation of the turning arm in concert with the rapidly moving speed-up friction belt still accelerating the non-elevated edge of the lumber piece results in forward movement of the non-elevated edge, that is the trailing edge of the lumber piece under and ahead of the forward elevated edge with the result that the lumber piece is inverted 180 degrees about its longitudinal axis.

A selectively actuable lift skid is cooperatively positioned, for example mounted laterally of the board turning device. Operation of the lift skid arm is in response to a signal received from a remote scanner, or other sensing device, which has determined that the lumber piece does not require turning. By way of example, a board that does need not be turned could be either wane free or have the wane correctly oriented for the planer.

As a lumber piece that does not require turning enters on to the speed-up friction belt, the lift skid arm is actuated to momentarily elevate the lumber piece. Translation of this lumber piece is thereby stalled a sufficient time interval to avoid contact with the corresponding raised turning arm. Once the lumber piece is clear of the turning arm the lift skid arm is lowered to return the lumber piece into the same lug space with no interruption in the speed of the lugged transfer.

In summary, the present invention may be characterized in one aspect as a device for selectively inverting a workpiece about the longitudinal axis of the workpiece within a single lug space of a lugged transfer without impeding lumber flow along a flow path on the lugged transfer, wherein the device includes a workpiece speed-up for urging the workpiece at an increased translation speed along the flow path, a selectively operable workpiece brake to inhibit accelerated translation of the workpiece by the workpiece speed-up so as to selectively at least momentarily delay translation of the workpiece at the increased translation speed of the workpiece speed-up, and a workpiece turning arm mounted downstream along the workpiece speed-up. The board turning arm is selectively actuable into the flow path so as to invert the workpiece about its longitudinal axis within a corresponding lug space of the lugged transfer once the workpiece has been translated by the speed-up to a downstream end of the corresponding lug space.

The workpiece speed-up engages the workpiece in the lug space and accelerates and translates the workpiece to a downstream end of the lug space as the lug space passes the workpiece speed-up unless the workpiece is delayed by operation of the workpiece brake. In one embodiment, the workpiece speed-up may be a continuous speed-up belt aligned substantially along the flow path and the workpiece brake may be a lift skid mounted under the flow path and selectively actuable into the flow path so as to urge the workpiece out of contact with the workpiece speed-up.

In one embodiment, the board turning arm may be pivotally mounted under the flow path on a fulcrum between the ends of the arm. When actuated into the flow path, the board turning arm pivots and thereby raises a first end of the arm into the lug space. The first end of the arm engages and raises a downstream-most edge of the workpiece, once the workpiece has been accelerated and translated downstream along the lug space by the workpiece speed-up, so that an opposite upstream-most edge of the workpiece is translated downstream along the lug space and under the downstream-most edge of the workpiece as the downstream-most edge is raised by the first end of the turning arm so as to invert the workpiece.

A co-ordinating means may be provided for co-ordinating actuation of the workpiece turning arm with translation of the lug space along the flow path so as to actuate the turning arm at the downstream end of the lug space as the lugged transfer translates the workpiece along the flow path past the turning arm. The co-ordinating means may, in one embodiment, include a cam co-operating with a cam follower on the turning arm.

The cam may include an arcuate track so that the cam follower follows in the track. The turning arm may be translated on a translation means along the flow path. The arcuate track may lie in a vertical plane and may be mounted so that the track does not extend above the flow path. The translation means may be an endless conveyor lying in a parallel vertical plane, wherein the endless conveyor translates at a speed equivalent to a translation speed of the lugged conveyor. The track may have an arcuately lowered portion along its length so that the cam follower is lowered as the downstream end of the corresponding lug space on the lugged conveyor translates over the arcuately lowered portion.

A plurality of the turning arms may be pivotally mounted on the endless conveyor, spaced apart by a distance substantially equivalent to the distance between the lug on the lugged conveyor.

### BRIEF DESCRIPTION OF THE DRAWINGS

FIG. 1, is a plan view of a portion of the board turner of the present invention.

FIG. 2 is a side elevation of the board turner illustrated in FIG. 1.

FIG. 3 is an isometric view of a portion of the board turner generally viewed on line 3-3 of Figure.

FIG. 4 is an enlarged view of the turning arms and associated drive and guide mechanism.

FIG. 5 is an elevation view of FIG. 4, partially broken away.

FIG. 6 is an enlarged schematic view of a portion of FIG. 2 illustrating operation of the speed-up belt and board turning arms.

FIG. 7 is an enlarged view similar to FIG. 4 illustrating operation of the lifting skid.

FIG. 8a is a view of a board on its approach to the board turner.

FIG. 8b is a view of a board being turned by the board turner.

FIG. 8c is a view of a board being elevated by the lifting skid so as to avoid being turned by the board turner.

FIG. 9 schematically illustrates a properly positioned waned board for passage through a planer.

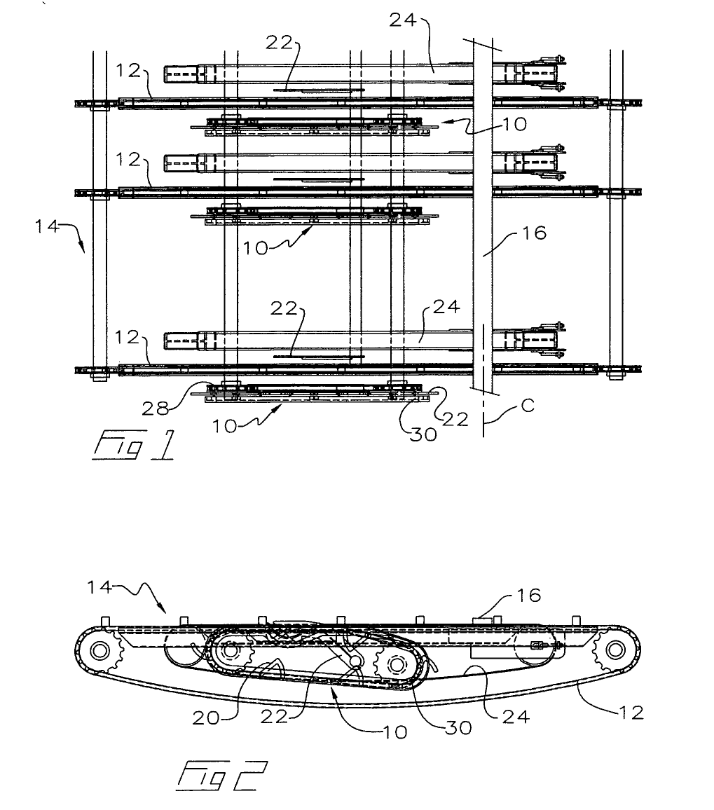

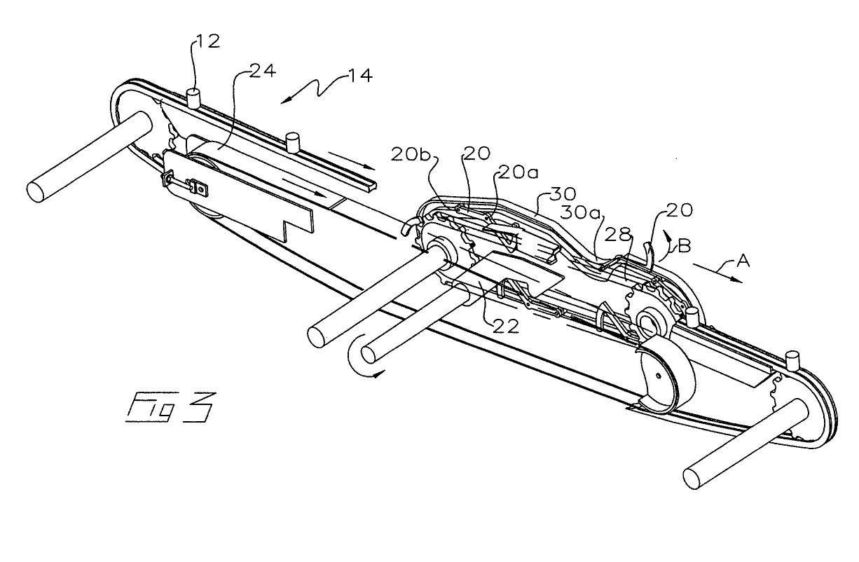

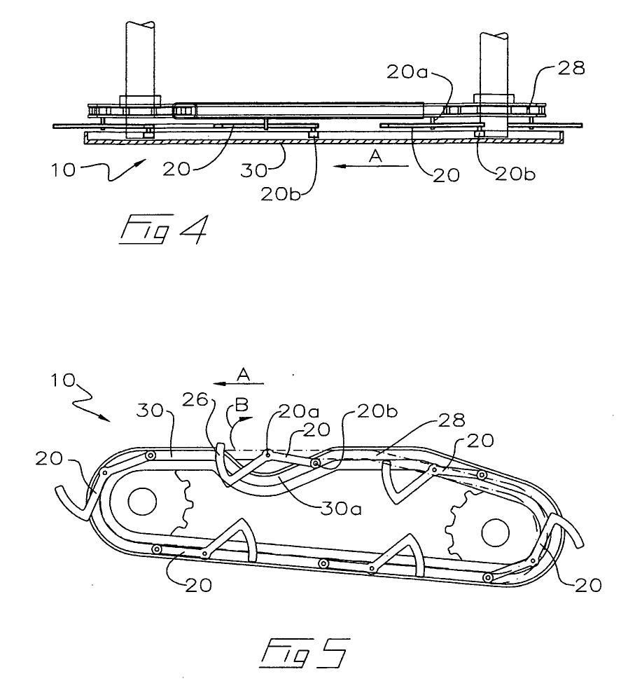

### DETAILED DESCRIPTION OF EMBODIMENTS OF THE INVENTION

With reference to the drawing figures, wherein similar characters of reference denote corresponding parts in each view, the high speed board turner 10 of the present invention is positioned in proximity to the plurality of chains 12 of a lugged transfer 14 common to sawmill and planer mill applications. Scanners or optimisers (not shown) normally assess lumber pieces 16 carried on lugged transfer 14 to identify wane 18 and the like defects, prior to approaching board turner 10.

Board turner 10 includes a board turning arm 20, a lift skid 22 and a speed-up belt 24. A plurality of turning arms 20 are rotatably mounted to drive chain 28. Chain 28 is positioned adjacent and parallel to one side of arms 20. Arms 20 are also mounted to a track 30 positioned on the other side of arms 20. Connecting pins 20a pivotally mount arms 20 to chain 28. Pins 20b mount the track follower ends of arms 20 to the wheels which run in the track. An arcuately shaped board contact leg 26 is located at the opposite free end of arm 20, that is, the end opposite to connecting pin 20b. The uppermost portion of track 30 is formed so that the follower wheels, when following along the track, dip along an arcuate depression 30a in the track. As pin 20b follows this path in direction A, board turning arm 20 pivots in direction B accordingly on connecting pin 20a to elevate board contact leg 26 into the path of a board an elevated carried in a lug space on lugged transfer 14. Drive chain 28 rotates continuously. Therefore each board contact leg 26 is elevated in succession above the surface of lugged transfer 14 whether or not a board is in position to be turned.

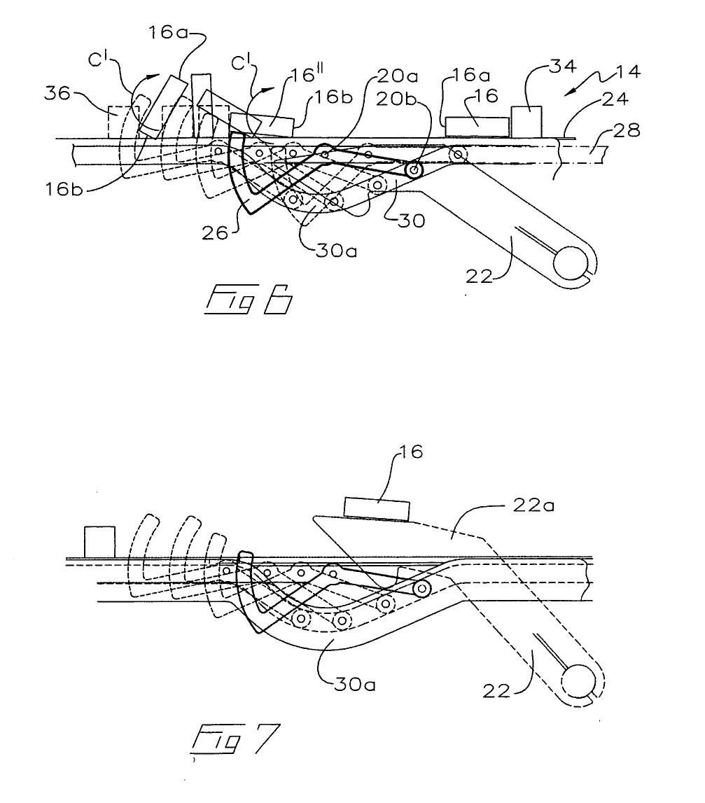

Speed-up belt 24 may be manufactured from fabric or smooth chain or other flexible material to provide a means of frictionally gripping an edge of a board to be turned. Speed-up belt 24 also rotates continuously, but at a higher rotational rate than the rotational rate of lugged transfer 14. Thus the upper surface of belt 24 is also moving in direction A. As boards 16, transported in the lug spaces of lugged transfer 14, are brought into contact with speed-up belt 24, they are accelerated from a first upstream position (see board 16′ in FIG. 6) on transporting lug 34 to the adjacent downstream lug 36 within the same lug space of lugged transfer 14, (see downstream positioned board 16″ in FIG. 6). Upon contact of board 16 with downstream lug 36, the rotation of turning arm 20 is synchronized to pivot arcuate board contact leg 26 upwardly in direction B into contact with the leading (downstream) edge 16a of board 16 lifting it arcuately upwardly. The friction of continuously moving speed-up belt 24 against the trailing (upstream) edge 16b of board 16 as it is further elevated, results in the edge 16b being pulled under edge 16a so as to invert board 16 in direction C′ 180 degrees about its longitudinal axis C and it back into the lug space behind lug 36.

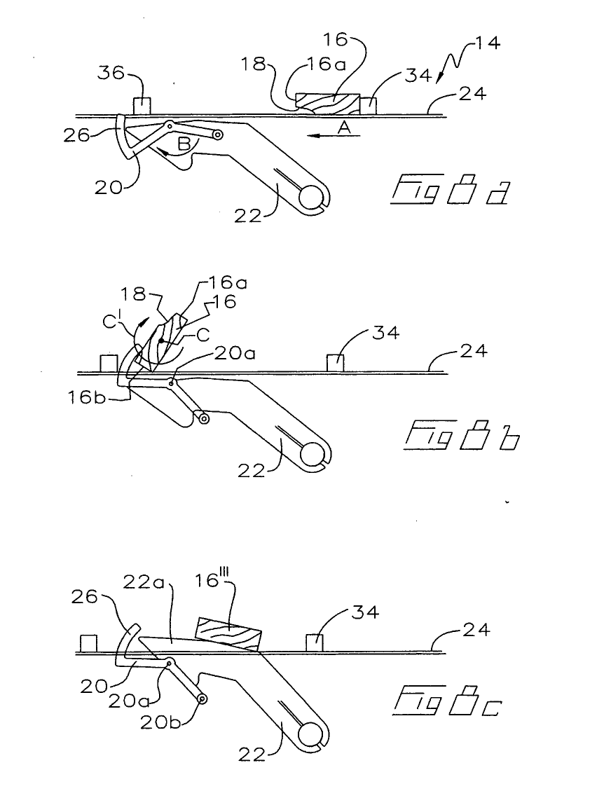

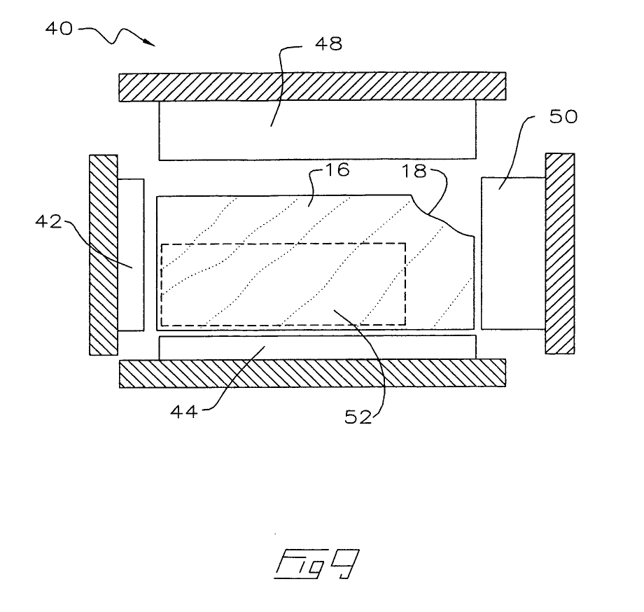

A selectively actuable lift skid 22 is positioned adjacent to board turning device 10 laterally interposed between speed-up belt 24 and a chain 12 of lugged transfer 14. Operation of lift skid 22 is in response to a signal received from a processor (not shown) on information from a downstream scanner or other sensor when the processor has determined that the lumber piece does not require turning. As a wane-free board 16′″ is carried by speed-up belt 24 toward board turner 10, as illustrated in FIG. 8c, lift skid 22 is actuated so as to rotate skid arm 22a upwardly into contact with the underside of the wane-free board. The continuous operation of speed-up belt 24 forces the board up the inclined face of a ramp surface 22b. Raising skid arm 22a momentarily elevates the board free from contact with belt 24, thereby delaying the downstream translation of board 16′″ thereby allowing board turner 10 to continuously cycle turning arms 20 through their lifting and retraction cycles without contact with the wane-free board 16′″. Lift skid 22 is lowered to drop the board back into the same lug space once the corresponding turning arm 20 is lowered or is lowering such that the leg 26 will not contact the wane-free board 16′″.

As is schematically shown in FIG. 9, planer 40 has linebar planing heads 42 and bedplate planing heads 44 each of which generally remove a minimum of material from the respective adjacent faces of board 16. Board 16 has been previously positioned on the planer lugged transfer in accordance with previously applied markings so that board 16 need only be turned 180 degrees about its longitudinal axis, when necessary, for proper planing orientation. As shown, proper planing orientation places wane 18 uppermost. Opposing planing heads 48 and 50 generally remove substantially more material from board 16 ensuring that finished board 52 is of the required dimensions and is also wane free.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A device for selectively inverting a workpiece about the longitudinal axis of the workpiece within a single lug space of a lugged transfer without impeding lumber flow along a flow path on the lugged transfer comprising a workpiece speed-up for urging the workpiece at an increased translation speed along the flow path,
a selectively operable workpiece brake to inhibit accelerated translation of the workpiece by said workpiece speed-up so as to selectively at least momentarily delay translation of the workpiece at said increased translation speed of said workpiece speed-up,
and a workpiece turning arm mounted downstream along said workpiece speed-up, said board turning arm selectively actuable into the flow path so as to invert the workpiece about its longitudinal axis within a corresponding lug space once the workpiece has been translated by said speed-up to a downstream end of the corresponding lug space.

2. The device of claim 1 wherein said workpiece speed-up engages the workpiece in the lug space and accelerates and translates the workpiece to a downstream end of the lug space as the lug space passes said workpiece speed-up unless the workpiece is delayed by operation of said workpiece brake.

3. The device of claim 2 wherein said workpiece speed-up is a continuous speed-up belt aligned substantially along said flow path.

4. The device of claim 1 wherein said workpiece brake is a lift skid mounted under said flow path and selectively actuable into said flow path so as to urge the workpiece out of contact with said workpiece speed-up.

5. The device of claim 3 wherein said workpiece brake is a lift skid mounted under said flow path and selectively actuable into said flow path so as to urge the workpiece out of contact with said workpiece speed-up.

6. The device of claim 1 wherein said board turning arm is pivotally mounted under said flow path and when actuated into said flow path, pivots and thereby raises a first end of said arm into the lug space so as to engage and raise a downstream-most edge of the workpiece, when the workpiece has been accelerated and translated downstream along the lug space by said workpiece speed-up, so that an opposite upstream-most edge of the workpiece is translated downstream along the lug space and under the downstream-most edge of the workpiece as the downstream-most edge is raised by said first end of said turning arm so as to invert the workpiece.

7. The device of claim 5 wherein said board turning arm is pivotally mounted under said flow path and when actuated into said flow path, pivots and thereby raises a first end of said arm into the lug space so as to engage and raise a downstream-most edge of the workpiece, when the workpiece has been accelerated and translated downstream along the lug space by said workpiece speed-up, so that an opposite upstream-most edge of the workpiece is translated downstream along the lug space and under the downstream-most edge of the workpiece as the downstream-most edge is raised by said first end of said turning arm so as to invert the workpiece.

8. The device of claim 1 further comprising co-ordinating means for co-ordinating actuation of said workpiece turning arm with translation of the lug space along said flow path so as to actuate said turning arm at the downstream end of the lug space as the lugged transfer translates the workpiece along said flow path past said turning arm.

9. The device of claim 7 further comprising co-ordinating means for coordinating actuation of said workpiece turning arm with translation of the lug space along said flow path so as to actuate said turning arm at the downstream end of the lug space as the lugged transfer translates the workpiece along said flow path past said turning arm.

10. The device of claim 8 wherein said co-ordinating means includes a cam co-operating with a cam follower on said turning arm.

11. The device of claim 9 wherein said co-ordinating means includes a cam co-operating with a cam follower on said turning arm.

12. The device of claim 6 further comprising co-ordinating means for co-ordinating actuation of said workpiece turning arm with translation of the lug space along said flow path so as to actuate said turning arm at the downstream end of the lug space as the lugged transfer translates the workpiece along said flow path past said turning arm, and wherein said co-ordinating means includes a cam co-operating with a cam follower on said turning arm, and wherein said cam follower is on a second end of said turning arm opposite from said first end, and said turning arm is pivotally mounted on a fulcrum between said first and second ends.

13. The device of claim 7 further comprising co-ordinating means for co-ordinating actuation of said workpiece turning arm with translation of the lug space along said flow path so as to actuate said turning arm at the downstream end of the lug space as the lugged transfer translates the workpiece along said flow path past said turning arm, and wherein said co-ordinating means includes a cam co-operating with a cam follower on said turning arm, and wherein said cam follower is on a second end of said turning arm opposite from said first end, and said turning arm is pivotally mounted on a fulcrum between said first and second ends.

14. The device of claim 12 wherein said cam is an arcuate track and said cam follower follows in said track, and wherein said turning arm is translated on a translation means along said flow path.

15. The device of claim 13 wherein said cam is an arcuate track and said cam follower follows in said track, and wherein said turning arm is translated on a translation means along said flow path.

16. The device of claim 14 wherein said arcuate track lies in a vertical plane and is mounted so that said track does not extend above said flow path, and wherein said translation means is an endless conveyor lying in a parallel vertical plane.

17. The device of claim 15 wherein said arcuate track lies in a vertical plane and is mounted so that said track does not extend above said flow path, and wherein said translation means is an endless conveyor lying in a parallel vertical plane.

18. The device of claim 16 wherein said endless conveyor translates at a speed equivalent to a translation speed of the lugged conveyor, and wherein said track has an arcuately lowered portion along its length so that said cam follower is lowered as the downstream end of the corresponding lug space on the lugged conveyor translates over said arcuately lowered portion.

19. The device of claim 17 wherein said endless conveyor translates at a speed equivalent to a translation speed of the lugged conveyor, and wherein said track has an arcuate portion along its length so that said cam follower is lowered as the downstream end of the corresponding lug space on the lugged conveyor translates over said arcuate portion.

20. The device of claim 18 wherein a plurality of said turning arms are pivotally mounted on said endless conveyor, spaced apart by a distance substantially equivalent to a length of the lug spaces on the lugged conveyor.

21. The device of claim 19 wherein a plurality of said turning arms are pivotally mounted on said endless conveyor, spaced apart by a distance substantially equivalent to a length of the lug spaces on the lugged conveyor.
